(19) United States
(12) Patent Application Publication
(10) Pub. No.: US 2002/0176415 A1
(43) Pub. Date: Nov. 28, 2002

(54) Channeling protocol data units

(76) Inventors: Patricia Ann Holden, Medway, MA (US); Bradford H. Kemp, Milton, MA (US); Daniel Trippe, Sudbury, MA (US)

Correspondence Address: FOLEY HOAG LLP, PATENT GROUP, WORLD TRADE CENTER WEST, 155 SEAPORT BOULEVARD, BOSTON, MA, 02110-2600, US

(21) Appl. No.: 10/012,905

(22) Filed: Nov. 13, 2001

Related U.S. Application Data
(60) Provisional application No. 60/293,023, filed on May 23, 2001.
(60) Provisional application No. 60/294,408, filed on May 30, 2001.

(51) Int. Cl. H04L 12/28

(52) U.S. Cl. 370/389; 370/395.53

(57) ABSTRACT

In general, in one aspect, the disclosure describes a method of channeling a protocol data unit. The method includes receiving a protocol data unit having a label, accessing data identifying a channel associated with the label, and transmitting the protocol data unit via the identified channel.

### REFERENCES TO RELATED APPLICATIONS

This claims priority to co-pending U.S. Provisional Application Serial No. 60/293,023; filed May 23, 2001, entitled “Systems and Methods for Concentrating Low Speed Traffic on a High Speed Link”; and U.S. Provisional Application Serial No. 60/294,408, filed May 23, 2001, entitled “Systems and Methods to Induce RSVP-TE Session Establishment”.

### BACKGROUND

Networks enable computers to exchange electronic information across vast distances. Such information includes e-mail, internet web-pages, chat messages, audio, and video. Information sent between computers is typically divided into a collection of smaller pieces called protocol data units. A computer receiving the protocol data units can reassemble them into the original information.

Protocol data units often travel through many different intermediate nodes en route to their destination. One type of intermediate node is a network router. A typical network router receives a protocol data unit, identifies the unit's ultimate destination, and determines the next network router (“the next hop”) that moves the unit further down a path leading to the destination.

A wide variety of techniques have been developed to speed delivery of protocol data units across a network. Many of these techniques enable routers to dynamically adapt to network changes such as a “network traffic jam” or some malfunction. For example, routers participating in an approach known as OSPF (Open Short Path First) continually share information with one another regarding the status of different links between the routers. Individual routers use this information to build routing tables that specify the next hop for a given destination. Routers can continually update their routing tables as new information about the network arrives. Due to the dynamic nature of routing, different protocol data units may travel different paths between the same two computers. As routing tables often keep track of a very large number of potential destinations, routing tables often grow quite large and finding the right routing table entry for a given destination can take some time.

While routing can quickly adapt to changing network conditions, a technique known as “label switching” can enhance a network traffic engineer's ability to define the path taken by protocol data units. Typically, label switching involves chaining together a series of labeled hops between routers to predefine a fixed path through the network. Once a protocol data unit has been assigned a label, the unit's journey through the labeled path is based on the unit's label instead of the protocol data unit's destination address. By crude analogy, a protocol data unit traveling via a label switched path is like a hiker following a trail of bread crumbs instead of using a map and compass.

A wide variety of label switching techniques have been developed including MPLS (Multi-Protocol Label Switching). In MPLS, a “label switched path” (LSP) connects one “Label Edge Router” (LER) to another via a series of intermediate “Label Switched Routers” (LSRs). For example, after receipt of a protocol data unit, a label edge router can add a label to the protocol data unit and transmit the protocol data unit to a label switched router in the label switched path. Based on the label added to the protocol data unit, the label switched router can determine the next label switched router in the label switched path without examining the protocol data unit's destination address. This process can repeat as the protocol data unit advances along the label switched path.

### SUMMARY

In general, in one aspect, the disclosure describes a method of channeling a protocol data unit. The method includes receiving a protocol data unit having a label, accessing data identifying a channel associated with the label, and transmitting the protocol data unit via the identified channel.

Embodiments may include one or more of the following features. The protocol data unit may include a destination address. The protocol data unit may be an IP (Internet Protocol) packet. The label may be an MPLS (Multi-Protocol Label Switching) Label, a VLAN (Virtual LAN) tag, or a GMPLS (Generalized MPLS) label.

The method may include establishing the label with a network router, for example, by requesting a label for messages transmitted from a downstream entity to the router. The establishing the label may also include sending data (e.g., a ping, ICMP Echo Message, or TCP or UDP datagram) to the router destined for the downstream entity.

The method may include stripping the label from the protocol data unit before the transmitting of the protocol data unit via the identified channel. The method may also include storing data in a table that associates different labels with different respective channels. The identified channel may be a channel of an nDS0 carrier, a DS1 carrier, a DS3 carrier, a subrate DS3 carrier, or a SONET carrier. The method may further include dechannelizing a protocol data unit received via incoming channels and, potentially, forwarding each dechannelized protocol data unit to the same router.

In general, in another aspect, the disclosure describes instructions for causing a processor to access information included in a protocol data unit that includes a label, access data identifying a channel associated with the label, and cause the protocol data unit to be transmitted via the identified channel.

In general, in another aspect, the disclosure describes a method of channeling an Internet Protocol (IP) packet. The method includes requesting a first MPLS (Multi-Protocol Label Switching) label from a network router for delivery of messages from a downstream entity to the router; sending a message to the router destined for the downstream entity; receiving, in response to the message, a request from the router for a second MPLS label for delivery of messages to the downstream entity; and storing data associating the second MPLS label with identification of a channel of a channelized carrier servicing the downstream entity. The method also includes receiving the Internet Protocol packet from the network router, the packet having the second MPLS label and a destination address; identifying the channel associated with the second MPLS label; stripping the label from the packet; and transmitting the packet via the identified channel. The method also includes dechannelizing a packet received from the downstream entity via the identified channel and forwarding the dechannelized packet to the router.

In general, in another aspect, the disclosure describes an apparatus for channelizing protocol data units. The apparatus includes a first interface to a channelized network carrier, a second interface to a non-channelized network carrier, a multiplexer for channelizing data for transmission over the channelized network carrier, and a processor for executing instructions. The apparatus also include storage of data associating different labels with different respective channels of the channelized network carrier and instructions for causing the processor to receive a protocol data unit via the second interface, the protocol data unit having a label; access the data to identify a channel associated with the protocol data unit label; and transmit the protocol data unit via the multiplexer over the identified channel.

Advantages will become apparent in view of the following description including the figures and claims.

### BRIEF DESCRIPTION OF THE DRAWINGS

FIGS. 1, 2, and 4 are diagrams illustrating operation of a device for channeling network protocol data units based on labels.

FIG. 3 is a diagram illustrating label-based channeling.

FIG. 5 is a flow-chart of a process for label-based channeling.

FIGS. 6-8 are diagrams illustrating establishment of a label with a router.

FIG. 9 is a flow-chart of a process for establishing a label with a router.

FIG. 10 is a diagram of a system for label-based channeling.

### DETAILED DESCRIPTION

Data transmission occurs over carriers. For example, a T1 carrier can deliver 193 bits (e.g., “1”s or “0”s) every 0.000125 seconds. These 193 bits form a T1 (a.k.a. DS1) frame. Different carriers can vary greatly in their capacities. For example, a T3 carrier can carry the information of 28 T1 carriers.

A carrier may carry a single unchanneled (“clear channel”) signal. For example, all 193 bits of a T1 carrier may carry the bits of a single signal. Alternatively, a carrier's capacity may be divided into channels. For example, a 193-bit T1 frame may be divided into 24 8-bit channels known as DS0 channels. To send a protocol data unit over a carrier channel, a network computer allocates a carrier channel and transmits the protocol data unit in channel-sized pieces. For example, a T1 carrier channel can carry 8-bits of a DS0 signal in each frame. A receiver of the T1 carrier's DS0 channel can collect and reconstitute the bits into the original protocol data unit.

Channeling can occur at different levels. For example, a T2 carrier can carry four T1 channels or 96 DS0 channels; a T3 carrier can carry seven T2 channels, 28 T1 channels, or 672 DS0 channels; and so forth.

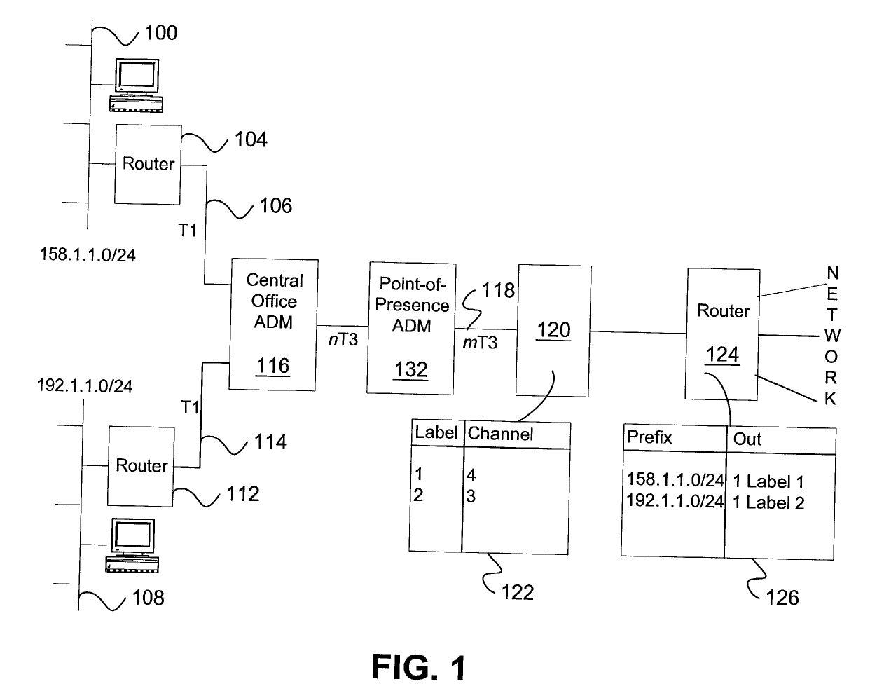

Described herein are techniques that use labels, such as MPLS (Multi-Protocol Label Switching) labels, to identify a carrier channel for carrying a protocol data unit. This label-based determination can speed delivery of protocol data units. Additionally, a device using these techniques need not implement a routing protocol (e.g., OSPF), maintain a routing table, or perform many other tasks associated with routing. Thus, such a device may be comparatively inexpensive to build and maintain. To illustrate these techniques, FIG. 1 depicts a sample environment in which a device 120 uses labels to channelize protocol data units received from a router 124 onto a carrier 118.

In greater detail, FIG. 1 depicts two different sub-networks 100, 108. In the example shown, each sub-network 100, 108 is identified by a sub-network address. For example, a sub-network address of “158.1.1.0/24” identifies sub-network 100. The first portion (“1158.1.1.0”) features a 4-byte (32-bit) IP (Internet Protocol) address expressed as a series of four numbers separated by a period. The second portion (“/24”), known as an address mask, identifies the number of bits shared by addresses in the sub-network 100. For example, a mask of “/24” indicates that addresses in sub-network 100 share the first 24-bits (the first three bytes). Thus, the sub-network 100 can include addresses ranging from “158.1.1.0” to “158.1.1.255”.

As shown, sub-networks 100, 108 can communicate with network entities outside the sub-network 100, 108 via a router 104, 112. Many routers 104, 112 feature high-speed links 106, 114 to other network entities. For example, as shown, routers 104, 112 connect to T1 carriers 106, 114. Other sub-network routers may connect to greater or lesser carriers. For instance, the routers 104, 112 may feature a DS0 carrier, a carrier of multiple DS0s (“a factional T1 carrier”), a T3 carrier, and so forth. These carriers 106, 114 may be channelized or “clear channel” carriers.

As shown, a central office 116 often receives multiple sub-network 100, 108 carriers 106, 114 and combines (“multiplexes”) them for transmission via an higher-speed channelized-link. For example, as shown, the central office 116 can transmit information over an n×T3 carrier. For instance, central office 116 may connect to an OC-12 fiber optic link that carries the information carried by 3×T3 carriers (e.g., 84-T1 carriers). The n×T3 carrier may terminate at a point-of-presence 132 or other add/drop multiplexer (ADM) that, for example, “peels” off T3 line(s) of interest.

As shown, device 120 communicates with the point-of-presence ADM 132 via channelized carrier 118. The device 120 also communicates with a network router 124. More specifically, the device 120 dechannelizes protocol data unit received over the channelized carrier 118 and forwards the reconstituted protocol data units to the router 124 for delivery to their network destinations.

For protocol data units flowing in the other direction, the device 120 channelizes and transmits the protocol data units received from the router 124 over carrier 118. Channeling the protocol data units onto channelized carrier 118 can effectively coordinate delivery of the data unit from the device 120 all the way to the sub-network of the packet's 128 destination.

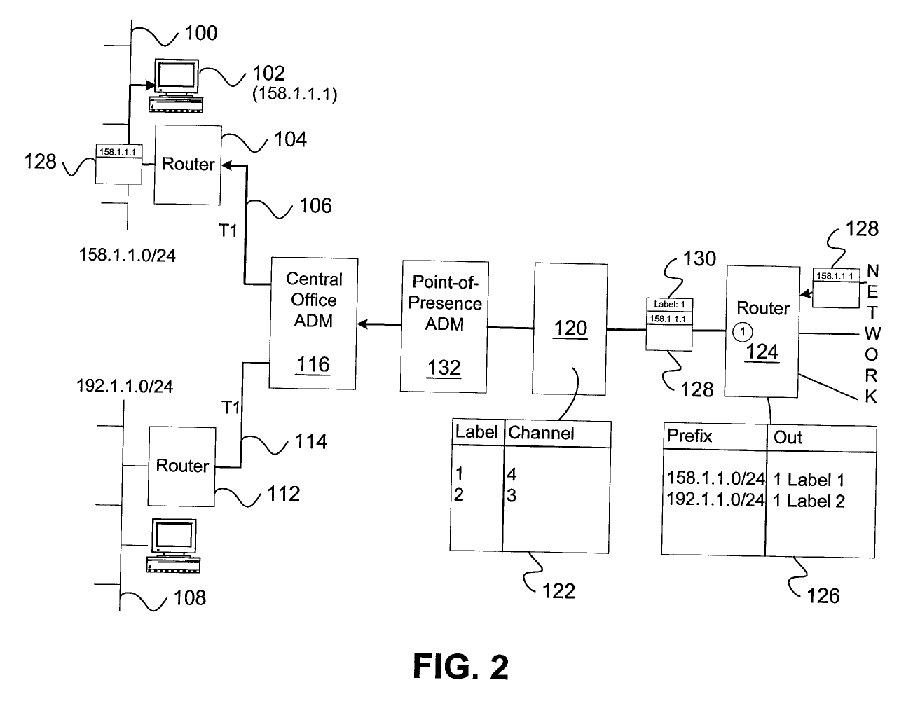

As shown, the device 120 can access data 122 that associates different labels, such as an MPLS label, with different respective channels of the carrier 118. The device 120 establishes these labels with router 124 such that the router 124 adds these labels to the protocol data units before transmitting the protocol data units to the device 120. For example, the router 124 can add a label to a protocol data unit by accessing a table 126, known in MPLS terminology as a “Label Information Base”, that associates different labels with different network destinations (e.g., sub-network 100). After establishing the label with the router 124, the device 120 can channelize protocol data unit received from the router 124 by examining the label added to the protocol data unit by the router 124 and looking up the label in data table 122 to identify a carrier 118 channel for transmission of the unit. To illustrate operation of the device 120, FIG. 2 traces the delivery of a protocol data unit 128 to its destination 102.

As shown in FIG. 2, router 124 receives a protocol data unit 128, in this case an IP (Internet Protocol) packet, having a destination address of “158.1.1.1”. Using this destination address, the router 124 determines whether a label should be added to the packet 128 by accessing its label information base 126. In the example shown, the destination address “158.1.1.1” falls within a range of addresses “158.1.1.0/24” of sub-network 100 associated with “Label 1” by the label information base 126. The table 126 also indicates that the packet 128 should be sent out interface “1” (shown as a circled “1” within router 124), leading to device 120. Thus, as shown in FIG. 2, the router 124 adds the label “1” 130 to the packet 128 and sends the packet 128 to device 120.

After receiving the packet 128, the device 120 examines the packet's 128 label 130. The device 120 then uses the label 130 to lookup a channel for carrying the packet 128 in table 122. In this example, the packet 128 label “1” indicates that the packet 128 should be transmitted via channel “4”. After stripping the label from the protocol data unit, the device 120 transmits the packet 128 via channel “4” of channelized carrier 118. Upon receipt, the central office 116 de-multiplexes the signal into its constituent carriers (e.g., T1 carriers 106 and 108). The central office 116 then transmits the packet via carrier 106 to router 104. If carrier 106 is a channelized carrier, the router 104 can de-channelize the carrier 106 and route the packet 128 to its sub-network 100 destination 102.

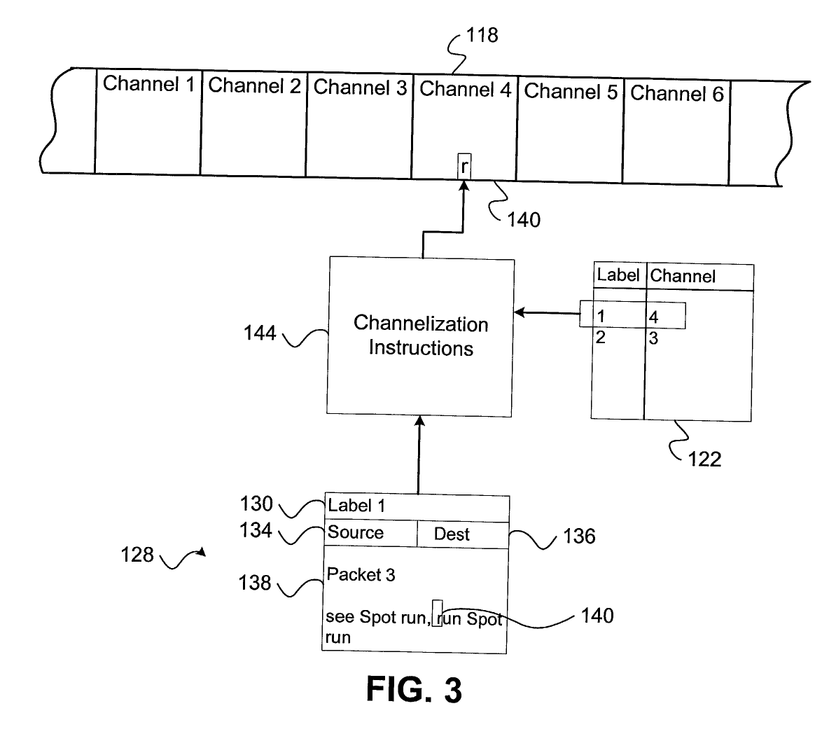

FIG. 3 illustrates an example of packet 128 channelizing in greater detail. As shown, the packet 128 includes source 134 and destination 136 addresses that enable network devices to route the packet 128 to its destination using a variety of network routing protocols (e.g., “layer 3 routing”). The packet 128 also includes “payload” 138 that stores the content (e.g., e-mail, web-page, and so forth) being transmitted. As shown, the packet 128 also includes a label 130, for example, added by a router in accordance with a label switching protocol.

FIG. 3 also depicts a carrier 118 that includes six channels. Some carriers (e.g., T1, T3, and SONET) feature TDM (Time Division Multiplexing) Channels where a channel receives a slice of time to transmit information. Other carriers feature other types of channels such as FDM (Frequency Division Multiplexing) Channels where each channel is allocated a range of carrier frequencies. The techniques described herein do not rely on a particular type of channel.

To select a channel for transmitting a packet 128, channelization instructions 144 examine the packet's 128 label 130 and lookup the label 130 in a table 122 associating labels with designated channels. The table 122 may include additional information in addition to a channel. For example, for a T3 carrier, the table 122 may identify a T1 carrier included in the T3 signal in addition to the channel of the T1 carrier (e.g., “Channel 4 of T1 26”). Again, placing packet 128 information into the appropriate channel can effectively coordinate delivery of the packet 128 from the device 120, depicted in FIG. 2, all the way to the sub-network of the packet's 128 destination.

In the example shown, the table 122 associates label “1” with carrier channel “4” (e.g., DS0 channel 4). The channelization instructions 144, thus, use channel “4” to transmit packet 128. For example, as shown, the instructions 144 transmit a portion 140 of packet 128 payload 138 via the channel. Again, a channel receiver can reconstitute the packet 128 from its channelized portions 140.

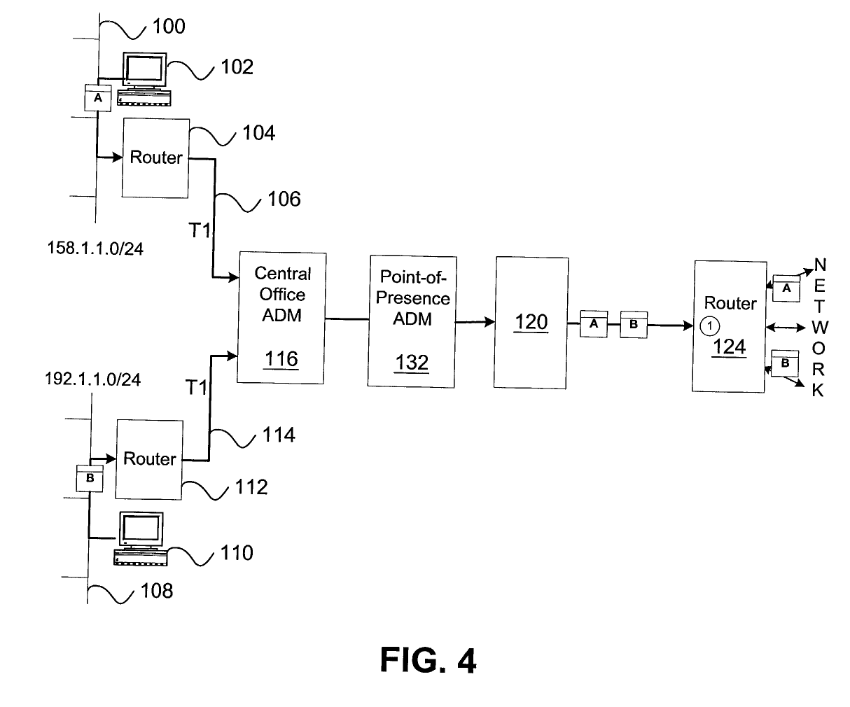

As shown in FIG. 4, in addition to channelizing protocol data units for transmission via a channelized carrier 118, the device 120 can also de-channelize protocol data units received over the carrier 118. For example, as shown in FIG. 4, computers 102 and 110 transmit packets “A” and “B”, respectively. As shown, routers 104, 112 transmit these packets to the central office 116 via carriers 106, 114. The central office 116 in turn transmits the packets to device 120 via point-of-presence 132. As shown, the device 120 de-channelizes the packets received over channelized carrier 118. As packets received by the device 120 are overwhelmingly destined for the core network, forwarding the packets to the same router does not substantially degrade network communication speed and, again, can permit the device 120 to operate without implementing routing algorithms. Finally, as shown, the router 124 routes the packets on their respective ways to their network destinations.

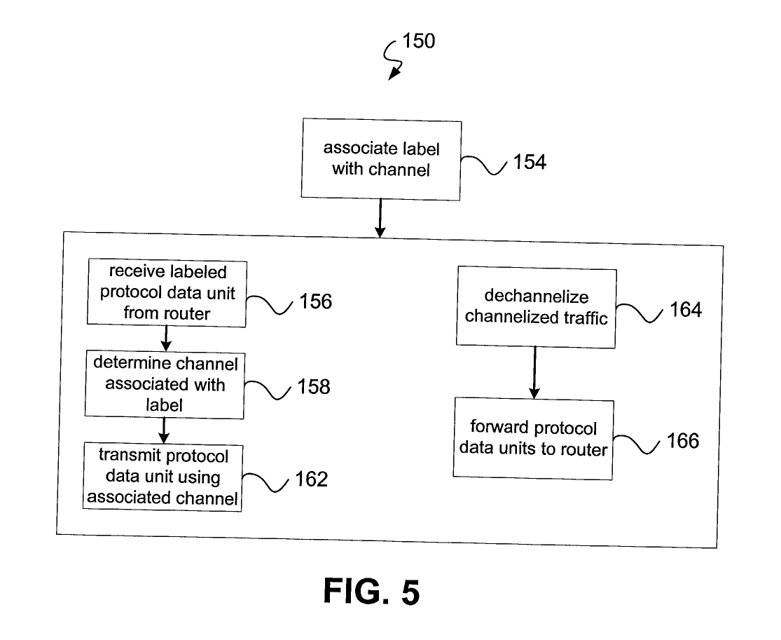

FIG. 5 illustrates a process 150 for handling protocol data units using a channelized carrier. As shown, the process 150 associates 154 a label with a channel of the carrier. This association may repeat for each new label/channel pairing. Such association may be made statically, for example, by an operator who specifies a channel and label. Alternatively, the association of label and channel may occur dynamically, for example, using a label management protocol such as LDP/CR-LDP (Constraint-Based Routing-Label Distribution Protocol) or RSVP-TE (Resource ReSerVation Protocol-Traffic Engineering).

As shown in FIG. 5, the process 150 channelizes protocol data units for transmission over a carrier and de-channelizes protocol data units received from the carrier. For protocol data units being transmitted over the carrier, the process 150 determines 158 the channel associated with the label of a received 156 protocol data unit and transmits 162 the protocol data unit over the associated channel.

For information received from the carrier, the process 150 dechannelizes 164 the channelized traffic and forwards 166 the dechannelized protocol data units to a router for delivery to the protocol data unit's destination. The device 112 is not precluded from adding a label to a protocol data unit being delivered to the router.

As described above, the device establishes a label with a network router. The router then adds the established label to a protocol data unit before transmitting the unit to the device. To establish a label, the device may use a variety of different techniques.

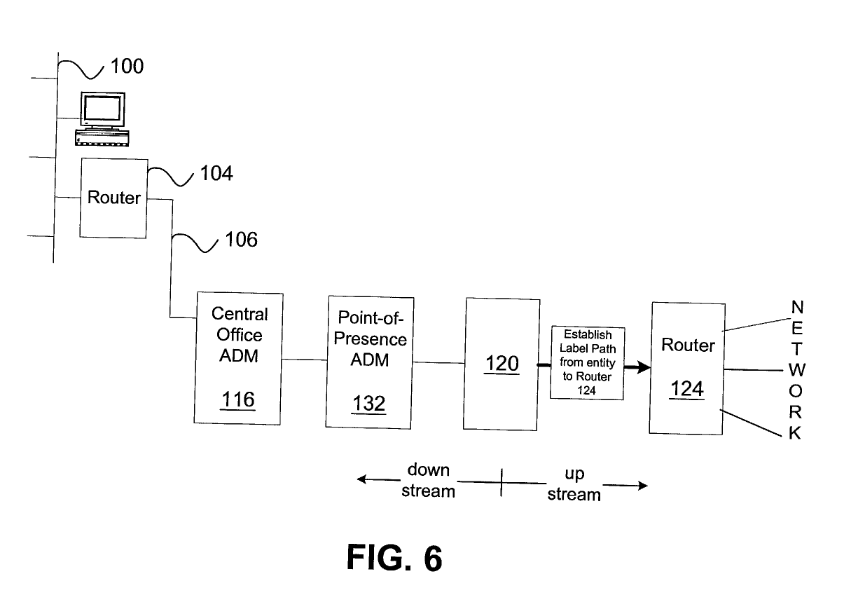

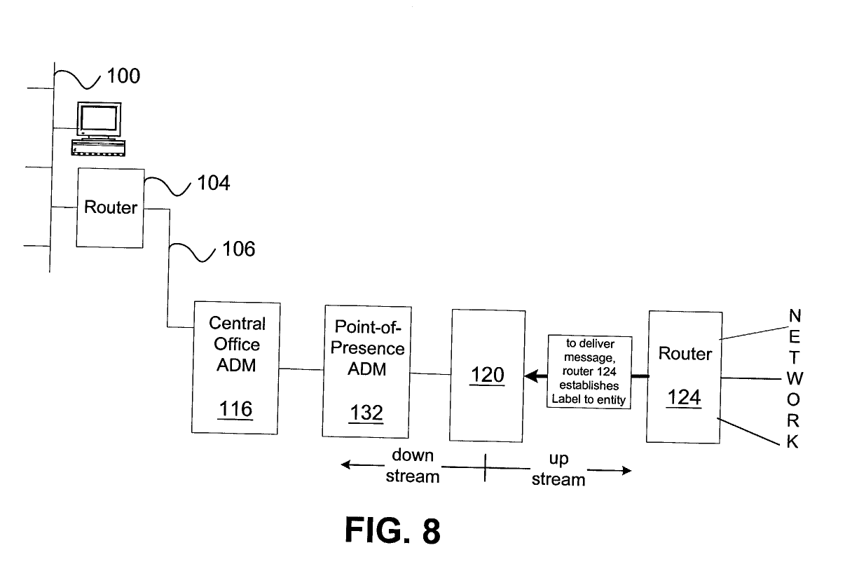

Unfortunately, some protocols do not currently support unsolicited label assignment. That is, device 120 cannot simply issue a request to router 124 to establish a label for protocol data units sent to device 120. FIGS. 6-8, however, illustrate a technique that can coerce an upstream entity (e.g., router 124 in FIG. 1) into requesting a label from an entity such as device 120.

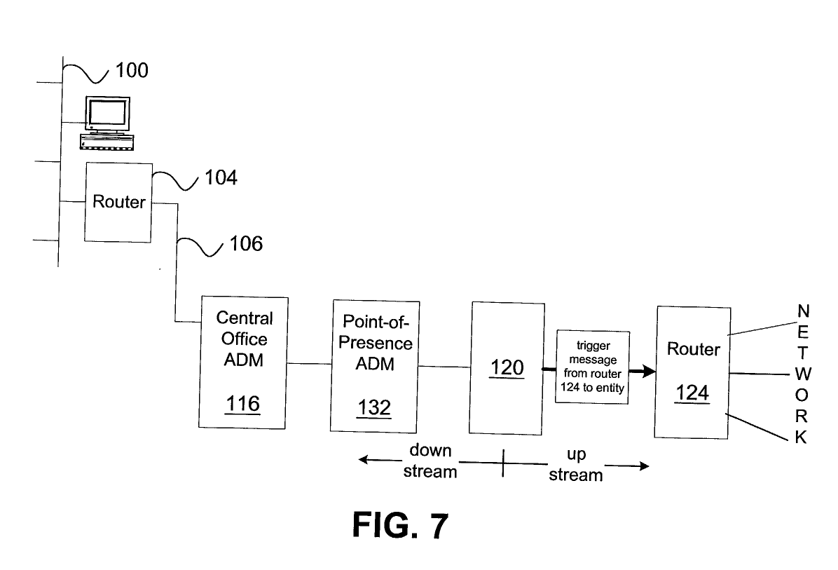

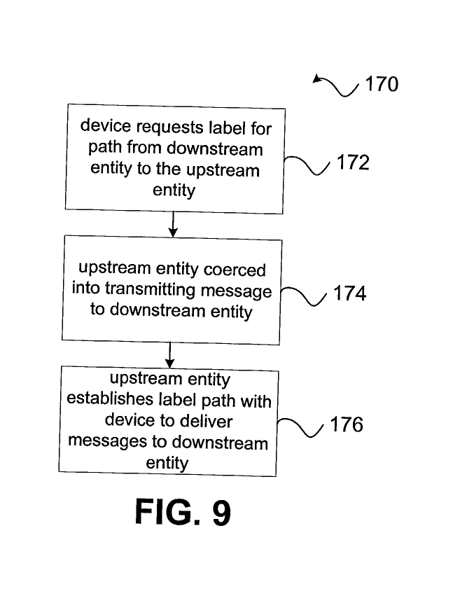

In greater detail, as shown in FIG. 6, the device 120 initially establishes a label-switched path with the upstream entity, router 124, on behalf of some downstream entity (e.g., router 104). That is, the device 120 can send a message indicating that a label-switched path is being established for protocol data units being transmitted by router 104 to router 124. Though no such path may actually be established, upon receiving a message destined for router 104, router 124 will attempt to establish a label-switch path in the other direction (e.g., a path from router 124 to router 104). Thus, as shown in FIG. 7, device 120 sends a message (e.g., a “ping”) destined for router 104 to router 124. As shown in FIG. 9, in response, router 124 will send a label request message to the device 120 to be used to send data to the router 104. Device 120 responds to router 124 with a label response message including the label to be used by router 124 when sending protocol data units to router 104.

The approach illustrated in FIGS. 6-8 may be used to establish labels in a variety of protocols such as RSVP-TE (Resource ReSerVation Protocol-Traffic Engineering) and CR-LDP (Constraint-Based Routing-Label Distribution Protocol).

For example, to establish a label using RSVP-TE, a device 120 can send a PATH request message to the router 124. The PATH message includes information to allow the router 124 to forward traffic to a downstream entity (e.g., router 104) via the device 120. This information can include an Explicit Routing Object (ERO) that identifies the router's 124 IP address, the device's 120 IP address, and the downstream router's 104 IP address; a Label Request Object (LRO); a tunnel session object that includes a TUNNEL_ID object; and a Sender Descriptor (SD) that includes the device's 120 IP address. The upstream router 124 will respond to the PATH message with a RESV message that includes a label. This exchange establishes a part of a path from the router 104 to router 124. Upstream router 124 is now aware that the device 120 and downstream router 104 will be using MPLS. Additionally, the upstream router 124 knows it can reach the downstream router 104 via the device 120.

Since RSVP-TE is a unidirectional protocol, the device 120 “tricks” the upstream router 124 to request a label-switched path in the other direction. For example, the device 120 can send a ping, ICMP (Internet Control Message Protocol) Echo message, TCP datagram, or UDP datagram, to upstream router 124 with a destination address of the downstream router 104. Since the router 124 knows of the downstream router 104 and its location downstream of device 120 due to the information included in the previous PATH message, the upstream router 124 sends a PATH message to the device 120 destined for the downstream router 104. The ERO of this PATH message includes the downstream router's 104 IP address, the device's 120 IP address and the upstream router's 124 IP address. The SD includes the upstream router's 124 IP address.

In response to this PATH message, the device 120 sends a RESV message with a label-object and ERO to the upstream router 124. The label object includes a label, defined by the device 120, that the upstream router 124 uses when sending protocol data units to the downstream router 104. The ERO, in this case, includes the downstream router's 104 IP address and the device's 120 IP address. This upstream to downstream session establishment is repeated for other downstream routers or other network destinations serviced by device 120.

A similar technique can be applied using CR-LDP. When the LDP discovery process runs, the device 120 and upstream router 124 exchange LDP INITIALIZATION messages. LDP ADDRESS messages are then exchanged between these entities 120, 124 to update their respective mapping databases. The ADDRESS message sent by the device 120 includes the IP address for downstream entities (e.g., routers 104) to be serviced. The device 120 then sends a LABEL-REQUEST message to the upstream router 124. The upstream router 124 responds with a LABEL MAPPING message. This message exchange establishes a label in one direction, from the downstream router 104 to the upstream router 124 via the device 120.

To force the upstream router 124 to establish a label-switched path with the downstream router 104 in the other direction, the device 120 sends a ping packet, or other message as described above, toward the upstream router 124 with a source address of the device 120 and a destination address of the downstream router 104. In response, the upstream router 124 sends a LABEL-REQUEST message to the device 120 to get the label for the downstream router 104. The device 120 then sends a LABEL MAPPING message to the upstream router 124 including the label to be used for the downstream router 104. This process repeats for different downstream entities being serviced by the device 120.

FIG. 9 illustrates this approach of establishing a label for delivery of protocol data units from an upstream entity to a downstream entity. As shown, the device requests 172 a label from the upstream entity for delivery of messages from the downstream entity to the upstream entity. The device then coerces 174 (e.g., by pinging) the upstream entity into transmitting a message to the downstream entity. In response, the upstream entity requests a label from the device for use in delivering messages to the downstream entity. The approach illustrated by FIG. 9 can permit a device 120 to establish a label for upstream-to-downstream communication without imposing a requirement that device 120 have knowledge of network routing or topology.

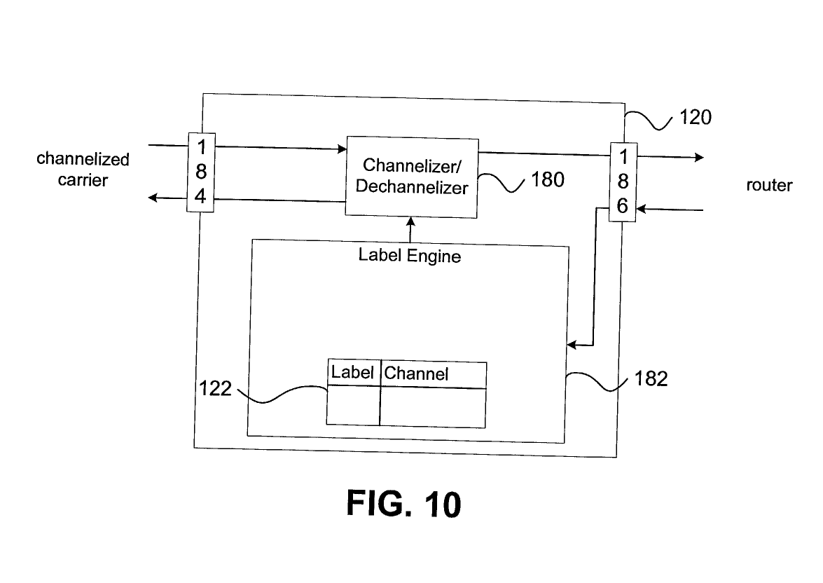

FIG. 10 illustrates an example of a channelizing device 120 in greater detail. As shown, the device 120 includes an interface 184 to a channelized carrier and an interface to a non-channelized 186 carrier. As shown the device 120 also includes a label engine 182 that stores and accesses data 122 associating different labels with different respective channels. The label engine 182 also performs other tasks such as label negotiation and assignment with network peers (e.g., router 124 in FIG. 1).

As shown in FIG. 10, the device 120 also includes channelizer/dechannelizer components 180. Such components 180 may be provided using a variety of hardware, software, and/or firmware architectures. For example, the channelizer/dechannelizer components 180 may include DS1 and DS3 framers and a M13 multiplexer/demultiplexer. The components 180 may include SONET framers, for example, using virtual tributaries (VT) multiplexing of T1 or E1 channels. The components 180 may also include HDLC (High-Level Data Link Control) framers. Further, multilink technologies, such as multilink PPP (Point-to-Point Protocol) or multilink Frame Relay, may be used in which multiple T1 links carry a single stream of packets from the central office ADM 116 in FIG. 1 to and from the routers 104, 112. Multilink streams are recombined onto the clear channel packet stream to router 124 in FIG. 1 or fragmented in the opposite direction by the channelizer/dechannelizer 180 in FIG. 10.

While the examples featured IP packets and MPLS labels, the techniques described herein may be used in a wide variety of environments. For example, the protocol data units need not be IP packets, but may instead, for example, be ATM (Asynchronous Transfer Mode) cells. Additionally, a wide variety of labeling technologies may be used instead of MPLS such as VLAN (Virtual LAN) tags or GMPLS (Generalized MPLS) labels. It should also be noted that the channelized carrier need not be a Tn or n×Tn carrier, but may instead feature other carrier capacities/frames such as SONET, nDS0, subrate DS3, and so forth. Additionally, the channel granularity may be configured. Further, different channel bandwidths may be used simultaneously.

The techniques described herein are not limited to any particular hardware or software configuration. The techniques may be implemented in hardware or software, or a combination of the two. Preferably, the techniques are implemented in computer programs executing on programmable computers that each include a processor, a storage medium readable by the processor (including volatile and non-volatile memory and/or storage elements), at least one input device, and one or more output devices.

Each program is preferably implemented in high level procedural or object oriented programming language to communicate with a computer system. However, the programs can be implemented in assembly or machine language, if desired. In any case the language may be a compiled or interpreted language.

Each such computer program is preferably stored on a storage medium or device (e.g., CD-ROM, hard disk, or magnetic disk) that is readable by a general or special purpose programmable computer for configuring and operating the computer when the storage medium or device is read by the computer to perform the procedures described herein. The system may also be considered to be implemented as a computer-readable storage medium, configured with a computer program, where the storage medium so configured causes a computer to operate in a specific and predefined manner.

Other embodiments are within the scope of the following claims.

1. A method of channeling a protocol data unit, the method comprising:
receiving a protocol data unit having a label;
accessing data identifying a channel associated with the label; and
transmitting the protocol data unit via the identified channel.

2. The method of claim 1, wherein the protocol data unit includes a destination address.

3. The method of claim 2, wherein the protocol data unit comprises an IP (Internet Protocol) packet.

4. The method of claim 1, wherein the label comprises one of the following: an MPLS (Multi-Protocol Label Switching) Label, a VLAN (Virtual LAN) tag, and a GMPLS (Generalized MPLS) label.

5. The method of claim 1, further comprising establishing the label with a network router.

6. The method of claim 5, wherein establishing the label with the network router comprises requesting a label for messages transmitted from a downstream entity to the router.

7. The method of claim 6, wherein establishing the label comprises sending data to the router destined for the downstream entity.

8. The method of claim 7, wherein the data comprises a ping.

9. The method of claim 7, wherein the data comprises at least one of the following: an ICMP (Internet Control Message Protocol) Echo message, a TCP (Transmission Control Protocol) datagram, and a UDP (User Datagram Protocol) datagram.

10. The method of claim 1, further comprising stripping the label from the protocol data unit before the transmitting of the protocol data unit via the identified channel.

11. The method of claim 1, further comprising storing data in a table that associates different labels with different respective channels.

12. The method of claim 1, wherein the identified channel comprises a channel of at least one of the following: an nDS0 carrier, a DS1 carrier, a DS3 carrier, a subrate DS3 carrier, and a SONET carrier.

13. The method of claim 1, further comprising dechannelizing a protocol data unit received via incoming channels.

14. The method of claim 12, further comprising forwarding each dechannelized protocol data unit to the same router.

15. Instructions for causing a processor to:
access information included in a protocol data unit received over a network connection, the accessed information including a label;
access data identifying a channel associated with the label; and
cause the protocol data unit to be transmitted via the identified channel.

16. The instructions of claim 15, wherein the protocol data unit includes a destination address.

17. The instructions of claim 16, wherein the protocol data unit comprises an IP (Internet Protocol) packet.

18. The instructions of claim 15, wherein the label comprises one of the following: an MPLS (Multi-Protocol Label Switching) Label, a VLAN (Virtual LAN) tag, and a GMPLS (Generalized MPLS) label.

19. The instructions of claim 15, further comprising instructions for causing the processor to establish the label with a network router.

20. The instructions of claim 19, wherein the instructions for causing the processor to establish the label with the network router comprise instructions for causing the processor to request a label for messages transmitted from a downstream entity to the router.

21. The instructions of claim 20, wherein the instructions for causing the processor to establish the label comprise instructions for causing the program to send data to the router destined for the downstream entity.

22. The instructions of claim 15, further comprising instructions for causing the processor to strip the label from the protocol data unit before the transmitting of the protocol data unit via the identified channel.

23. The instructions of claim 15, further comprising instructions for causing the processor to store data in a table that associates different labels with different respective channels.

24. The instructions of claim 15, further comprising instructions for causing the processor to dechannelize protocol data units received via incoming channels.

25. The instructions of claim 24, further comprising instructions for causing the processor to forward each dechannelized protocol data unit to the same router.

26. The instructions of claim 15, wherein the instructions comprise firmware instructions.

27. The instructions of claim 15, wherein the instructions comprise executable software instructions.

28. A method of channeling an Internet Protocol (IP) packet, the method comprising:
requesting a first MPLS (Multi-Protocol Label Switching) label from a network router for delivery of messages from a downstream entity to the router;
sending a message to the router destined for the downstream entity;
receiving, in response to the message, a request from the router for a second MPLS label for delivery of messages to the downstream entity;
storing data associating the second MPLS label with identification of a channel of a channelized carrier servicing the downstream entity;
receiving the Internet Protocol packet from the network router, the packet having the second MPLS label and a destination address;
identifying the channel associated with the second MPLS label;
stripping the label from the packet;
transmitting the packet via the identified channel;
dechannelizing a packet received from the downstream entity via the identified channel; and
forwarding the dechannelized packet to the router.

29. An apparatus for channelizing protocol data units, the apparatus comprising:
a first interface, the first interface being to a channelized network carrier;
a second interface, the second interface being to a non-channelized network carrier;
a multiplexer for channelizing data for transmission over the channelized network carrier;
a processor for executing instructions; and
storage, the storage storing:
data associating different labels with different respective channels of the channelized network carrier; and
instructions for causing the processor to:
receive a protocol data unit via the second interface, the protocol data unit having a label;
access the data to identify a channel associated with the protocol data unit label; and
transmit the protocol data unit via the multiplexer over the identified channel.

30. The apparatus of claim 29, wherein the label comprises one of the following: an MPLS (Multi-Protocol Label Switching) Label, a VLAN (Virtual LAN) tag, and a GMPLS (Generalize MPLS) label.

31. The apparatus of claim 29, further comprising instructions for causing the processor to establish the label with a network router via the second interface.

32. The apparatus of claim 30, wherein the instructions for causing the processor to establish the label with the network router comprise instructions for causing the processor to request a label for messages transmitted from a downstream entity to the router.

33. The apparatus of claim 32, wherein the instructions for causing the processor to establish the label comprise instructions for causing the program to send data to the router destined for the downstream entity.

34. The apparatus of claim 29, further comprising instructions for causing the processor to strip the label from the protocol data unit before the transmitting of the protocol data unit via the identified channel.

35. The apparatus of claim 29, further comprising a demultiplexer.

36. The apparatus of claim 35, further comprising instructions for causing the processor to dechannelize protocol data units received via the first interface.

37. The apparatus of claim 35, further comprising instructions for causing the processor to forward each dechannelized protocol data unit to the same router via the second interface.
